(19) United States
(12) Patent Application Publication
(10) Pub. No.: US 2003/0090892 A1
(43) Pub. Date: May 15, 2003

(54) Drinking vessel capable of emitting light and sound

(76) Inventor: Chin-Lai Su, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,841

(22) Filed: Nov. 13, 2001

(51) Int. Cl. F21V 33/00

(52) U.S. Cl. 362/101; 362/86; 362/802; 362/800

(57) ABSTRACT

A drinking vessel capable of emitting light and sound includes a main containing body, a base sealing a lower opening of the containing body, a circuit board received in the base, and a mercury vibrating switch electrically connected to the circuit board. The circuit board has several LEDs, and a musical IC fitted thereto. When the main containing body is tilted, the mercury vibrating switch will complete the circuit for the LEDs and the musical IC to send out light, and music respectively.

### BACKGROUND OF THE INVENTION

The present invention relates to a drinking vessel, and more particularly, to one, which can send out light and music when it is used.

In order for people to get more pleasure from drinking with drinking vessels, a lot of effort has been put into making further attractive drinking vessels. Conventional ways of making drinking vessels with attractive look includes the use of various colors, patterns and materials, and of course different shapes. However, these conventional ways have their limitations, and the drinking vessels made therewith don't seem to satisfy the modern people any longer, especially the young people attending parties and so on.

### SUMMARY OF THE INVENTON

Therefore, it is a main object of the present invention to provide a drinking vessel which can attract people more in a way other than the conventional ones.

The drinking vessel of the present invention includes a main containing body, a base, a circuit board, and a mercury vibrating switch. The main containing body has a lower opening on the lower part. The base is secured to the lower part of the containing body to seal the lower opening, and is made of materials that allow light to travel through. The circuit board is received in the base, and has LEDs, batteries, and musical IC fitted thereto. The mercury vibrating switch is received ill the base, and electrically connected to the circuit board so as to be able to complete the circuit of the circuit board to cause the LEDs, and the musical IC to send out light, and music respectively when the containing body is tilted.

### BRIEF DESCRIPTION OF THE DRAWINGS

The present invention will be better understood by referring to the accompanying drawings, wherein:

FIG. 1 is an exploded perspective view of the drinking vessel capable of emitting light and sound of the present invention.

FIG. 2 is a cross-sectional view of the drinking vessel of FIG. 1.

FIG. 3 is a circuit diagram according to the present invention.

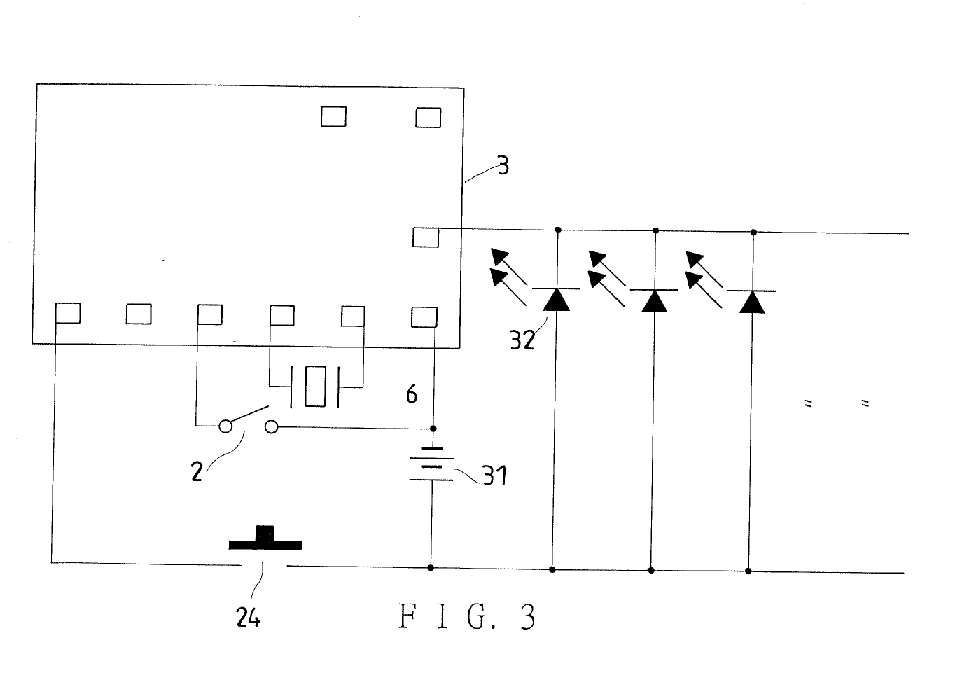

FIG. 4 is a view illustrating the use of the drinking vessel of the present invention.

### DETAILED DESCRIPTION OF THE PREFERRED EMBODIMENT

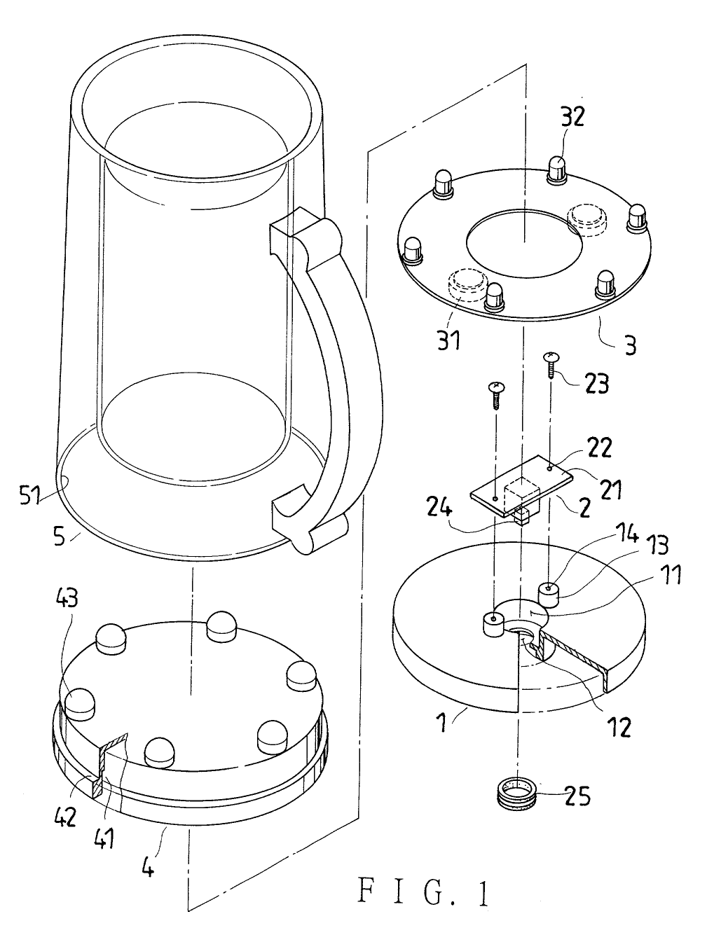

Referring to FIG. 1, a drinking vessel capable of emitting light and sound in the present invention includes a main containing body 5, a circuit board 3, a mercury vibrating switch 2, and a base consisting of both a lower part 1 and an upper part 4.

The main containing body 5 is made of materials that allow light to travel through, and has a lower opening 51 and an upper opening (not numbered). The circuit board 3 has a central hole, several LEDs 32 fitted on the upper side, and has a battery 31 fitted thereto. The mercury vibrating switch 2 includes a board part 21 having through holes 22, and a manual switch 24 fitted to a lower side of the board part 21. The lower part 1 of the base in includes a central receiving room 11, which is defined by both an annular wall and a bottom having a through hole 12; a seal 25 is removably fitted into the through hole 12 with an outer annular trench thereof being mounted on the bottom of the central receiving room 1.

The lower part 1 further has connecting protrusions 13, which stick up from the upper side, and are provided with screw holes 14.

The upper part 4 of the base includes a top board part (not numbered), hollow lamp guards 43 on the top board part, and an annular wall sticking downwards from the edge of the top board part to defined a receiving room together with the top board part; the lamp guards 43 are made of materials that allow light to travel through; the annular wall of the upper part 4 is formed with annular recesses 41 and 42 on the lower part of the inner side, and the upper part of the outer side respectively.

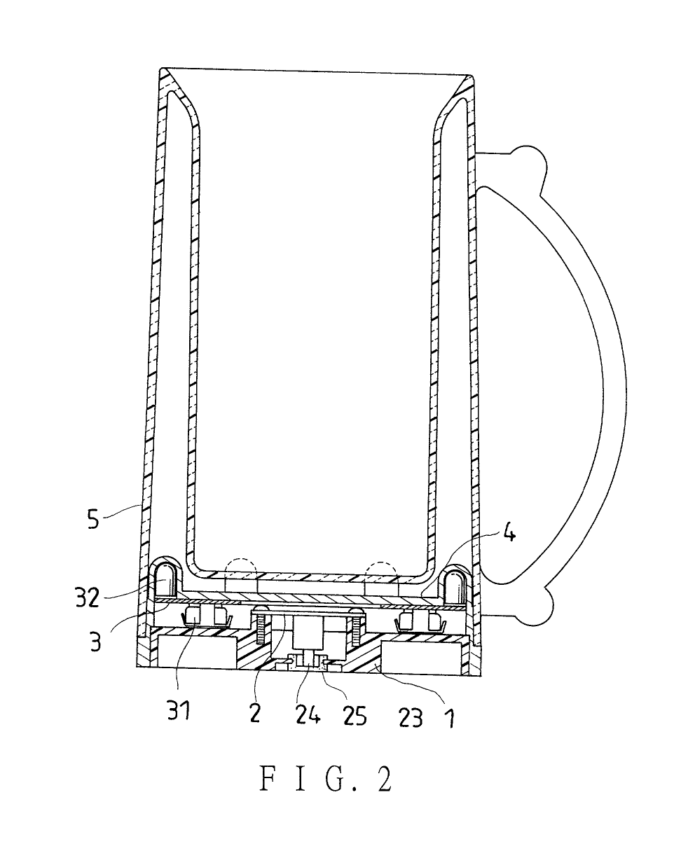

In combination, referring to FIG. 2, the board part 21 of the mercury vibrating switch 2 is secured to the base lower part, with the manual switch 24 being received in the receiving room 11 and with screws 23 being passed through the through holes 22 of the board part 21 and screwed into the screw holes 14 of the connecting protrusions 13. The circuit board 3 is fitted into the receiving room of the base upper part 4 with the LEDs 32 being each passed into one of the lamp guards 43. The base lower part 1 joined to the vibrating switch 2 is fitted into the receiving room of the base upper part 4 with the edge thereof abutting, and being fastened to, the lower annular recess 41 of the inner side of the base upper part 4, and with the vibrating switch 2 being electrically connected to the circuit board 3. Finally, the upper part of the base upper part 4 is fitted into the lower opening 51 of the main containing body 5 with the outer annular recess 42 abutting, and being fastened to, the inner side of the containing body 5.

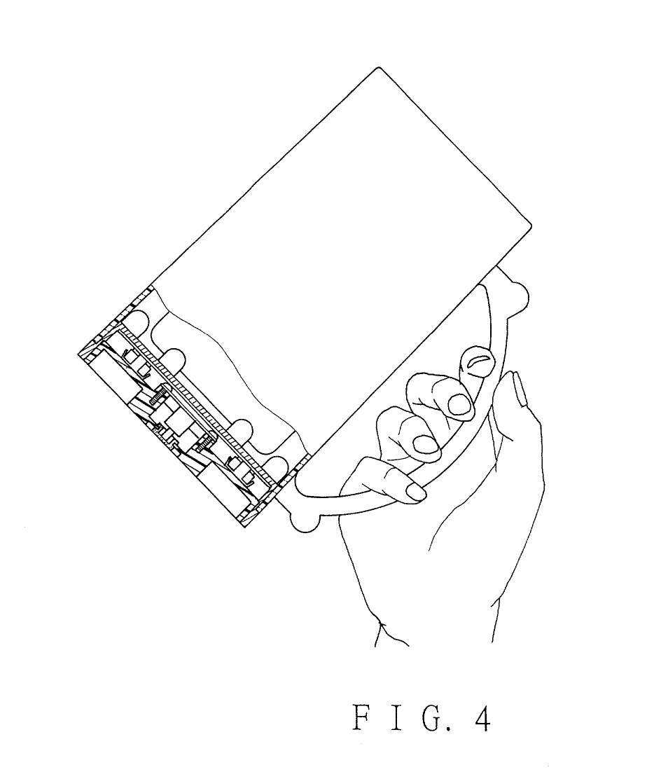

Referring to FIG. 4, when the user raises, and tilts the drinking vessel to drink the drinks in the containing body 5, the mercury vibrating switch 2 will be moved to the on position so as to complete the circuit of the circuit board 3, thus causing the LEDs 32 to emit light; the LEDs 32 can flash on take turns to send out light according to the design of the circuit board 3 such that the drinking vessel can look further attractive.

The manual switch 24 can be manually moved into an off position where the vibrating switch 2 can't complete the circuit, thus preventing the circuit board 3 from being unwantedly activated when the drinking vessel is not used or being transported.

In addition, the circuit board 3 can be equipped with buzzers 6 and musical IC such that the drinking vessel can send out music besides the light when it is used. And, the main containing body 51 can be provided with various colors to look further attractive.

From the above description, it can be easily seen that the drinking vessel of the present invention has advantages as follows:

1. The LEDs fitted to the base can scintillate or take turns to emit light to make the drinking vessel look attractive when the vessel is moved or tilted.

2. The drinking vessel can emit music with the musical IC to amuse the drinker when it is moved or tilted.

3. The harmony of the light and the music made by the LEDs and the musical IC can make the drinking vessel relatively pleasant to use.

What is claimed is:

1. A drinking vessel, comprising
a main containing body having a lower opening on a lower part;
a base secured to said lower part of said containing body to seal said lower openings;
a circuit board received in said base; said circuit board having a plurality LEDs and batteries fitted thereto;
a mercury vibrating switch; said switch being received in said base and electrically connected to said circuit board so as to be capable of completing a circuit of said circuit board to cause said LEDs to emit light when said containing body is moved to a tilted position.

2. A drinking vessel as claimed in claim 1 further comprising a musical IC fitted to said circuit board.
